(19) United States
(12) Patent Application Publication
(10) Pub. No.: US 2007/0176119 A1
(43) Pub. Date: Aug. 2, 2007

(54) Apparatuses and methods for analyzing semiconductor workpieces

(75) Inventor: Steve Hummel, Bend, OR (US)

Correspondence Address: PERKINS COIE LLP;PATENT-SEA, P.O. BOX 1247, SEATTLE, WA, 98111-1247, US

(73) Assignee: Accent Optical Technologies, Inc., Bend, OR (US)

(21) Appl. No.: 11/343,500

(22) Filed: Jan. 30, 2006

(51) Int. Cl. G01J 1/58

(52) U.S. Cl. 250/458.1

(57) ABSTRACT

Apparatuses and methods for analyzing semiconductor workpieces are disclosed herein. In one embodiment, for example, an apparatus for analyzing a semiconductor workpiece includes a first metrology unit configured to measure photoluminescence from the workpiece and a second metrology unit configured to determine a topographical profile of the workpiece. The apparatus can further include a control unit operatively coupled to the first metrology unit and the second metrology unit to receive and associate data regarding the photoluminescence and the topographical profile to produce an integrated map of the workpiece. The apparatus may have several different configurations. In one embodiment, for example, the first metrology unit and the second metrology unit can be housed in a single tool. In other embodiments, the first metrology unit and the second metrology unit may be in separate tools.

### TECHNICAL FIELD

The present invention generally relates to apparatuses and methods for analysis of semiconductor workpieces, such as semiconductor wafers or other semiconductor structures.

### BACKGROUND

Semiconductor devices and other microelectronic devices are typically manufactured on a workpiece (e.g., a semiconductor wafer) having a large number of individual dies (e.g., chips). Each workpiece undergoes several different procedures to construct the switches, capacitors, conductive interconnects, and other components of a device. For example, a workpiece can be processed using lithography, implanting, etching, deposition, planarization, annealing, and other procedures that are repeated to construct a high density of features. One aspect of manufacturing microelectronic devices is evaluating the workpieces to ensure that the microstructures are within the desired specifications and do not include defects that can negatively affect the various microelectronic components that are formed in and/or on the workpieces.

Photoluminescence spectroscopy is a non-contact, nondestructive method of probing the electronic structure of the workpiece to evaluate the extent of impurities and defects. More specifically, when silicon is excited with laser irradiation at an energy above the band-gap of the material, free electron hole pairs are produced. The electron hole pairs can recombine in a manner that causes luminescence. More specifically, the electron hole pairs formed can be trapped at defects and impurities in silicon such that the photons emitted during the recombination process provide a characteristic of the defects/impurities. Thus, photoluminescence spectroscopy is useful for detecting surface or near surface defects and contamination in the workpieces.

Many workpieces also include small geometric features on their surfaces at various stages of fabrication, and various tools and methods have been used to rapidly and accurately analyze the surface geometry of the workpieces to identify portions that are outside specified tolerances. One useful method for analyzing such features is measuring the workpiece's topology. More particularly, a workpiece's topology is a three-dimensional optical measurement of a surface of the workpiece and/or material on the surface. The topology can be measured using a non-contact optical measurement to determine the condition of the workpiece's surface (e.g., roughness) and/or imperfections at the surface (e.g., scratches, pits, bumps, smears, droplets, particulates, and/or mottled portions).

One challenge of evaluating workpieces during manufacturing is correlating the data used to analyze the workpieces. Conventional techniques include measuring various characteristics of the workpieces, but this data is generally not combined or used together in an efficient manner. Furthermore, it can be extremely expensive and time-consuming to accurately align and measure the workpieces within a variety of different measurement tools. Accordingly, there is a need to improve the process for evaluating workpieces.

### BRIEF DESCRIPTION OF THE DRAWINGS

FIG. 1 is a schematic illustration of an apparatus for analyzing a semiconductor workpiece in accordance with an embodiment of the invention.

FIG. 2 is a schematic illustration of an apparatus for analyzing a semiconductor workpiece in accordance with another embodiment of the invention.

FIG. 3 is a flow chart illustrating a method for analyzing a semiconductor workpiece in accordance with an embodiment of the invention.

FIG. 4 is a partially isometric view of a photoluminescence map of a semiconductor workpiece and a topographical map of the semiconductor workpiece overlaid into an integrated map in accordance with the method described in FIG. 3.

### DETAILED DESCRIPTION

A. Overview

The present invention is directed toward apparatuses and methods for analyzing surfaces of semiconductor workpieces and other types microelectronic substrates or wafers. One embodiment of the invention, for example, is directed to an apparatus for analyzing a semiconductor workpiece. The apparatus can include a first metrology unit configured to measure photoluminescence from the workpiece and a second metrology unit configured to determine a topographical profile of the workpiece. The apparatus can further include a control unit operatively coupled to the first metrology unit and the second metrology unit to receive and associate data regarding the photoluminescence and the topographical profile to produce an integrated map of the workpiece.

The apparatus can have several different configurations. In one embodiment, for example, the first metrology unit and the second metrology unit can be housed in a single tool. Further, the first metrology unit and the second metrology unit may be components within a single optical assembly and/or be configured to use a single optics subsystem. In other embodiments, the first metrology unit and the second metrology unit may be in separate tools.

Another embodiment of an apparatus for analyzing a semiconductor workpiece includes a radiation source configured to irradiate at least a portion of the workpiece. The apparatus also includes a first metrology unit configured to measure photoluminescence from the workpiece. The metrology unit can include (a) a first detector to measure photoluminescence from the irradiated portion of the workpiece, and (b) a first processor operatively connected to the first detector to produce a photoluminescence map of the workpiece. The apparatus can further include a second metrology unit configured to determine a topographical profile of the workpiece. The second metrology unit can include (a) a second detector to measure radiation reflected from the irradiated portion of the workpiece and generate a condition signal in response thereto, and (b) a second processor operatively coupled to the second detector for evaluating the geometry of the surface of the workpiece based on the condition signal to produce a topographical profile of the surface of the workpiece. The apparatus can also include a control unit operatively coupled to the first metrology unit and the second metrology unit to receive and associate data from the photoluminescence map and the topographical profile to produce an integrated map of the workpiece.

Several embodiments of the invention are also directed to methods for analyzing semiconductor workpieces. For example, one embodiment of a method in accordance with the invention includes irradiating a portion of a workpiece. The method also includes measuring photoluminescence and a topographical profile from the irradiated portion of the workpiece. The method further includes forming an integrated map of the workpiece based on the measured photoluminescence and topographical profile.

The following disclosure describes apparatuses and methods for analyzing surfaces of semiconductor workpieces and other types of microelectronic substrates or wafers. The term “workpiece” is defined as any substrate or wafer either by itself or in combination with additional materials that have been implanted in or otherwise deposited over the substrate. For example, semiconductor workpieces can include substrates upon which and/or in which microelectronic circuits or components, epitaxial structures, data storage elements or layers, and/or vias or conductive lines are or can be fabricated. Semiconductor workpieces can also include patterned or unpatterned wafers. Many specific details of certain embodiments of the invention are set forth in the following description to provide a thorough understanding and enabling description of these embodiments. A person skilled in the art, however, will understand that the invention may be practiced without several of these details or additional details can be added to the invention. Well-known structures and functions have not been shown or described in detail to avoid unnecessarily obscuring the description of the embodiments of the invention. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of items in the list.

B. Embodiments of Apparatuses for Analyzing Semiconductor Substrates

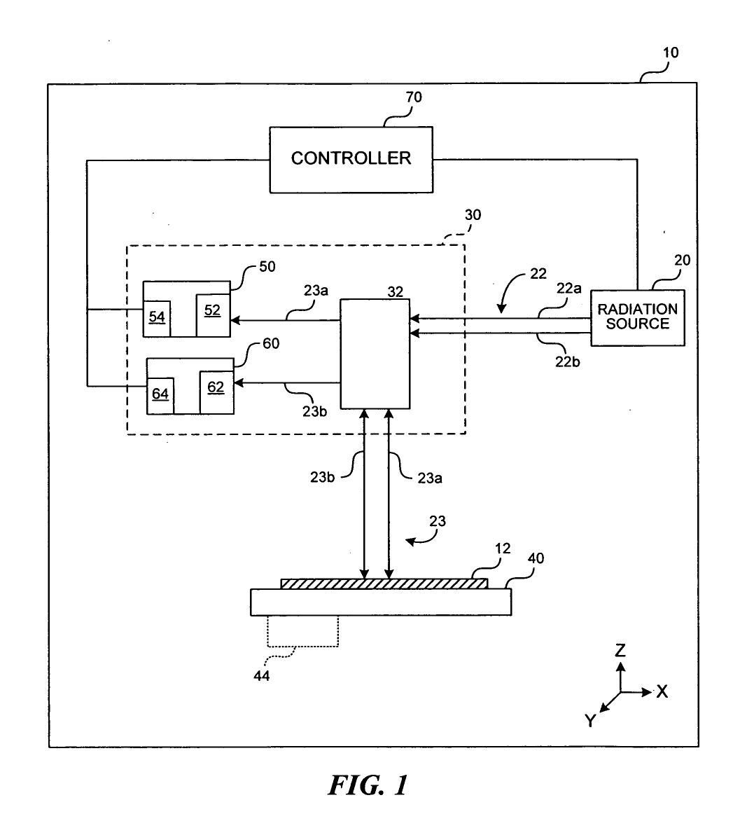

FIG. 1 is a schematic illustration of an apparatus 10 for analyzing a semiconductor workpiece 12 in accordance with an embodiment of the invention. The apparatus 10 is a tool configured to measure the photoluminescence and topography of the workpiece 12, and correlate the data into an integrated map of the workpiece. The resulting map provides an efficient and accurate tool for assessing the condition of the workpiece 12 at stages throughout manufacturing processes. For example, the integrated map can highlight specific kinds of defects on and/or in the workpiece 12, as well as accurately identify the location of the defect. In other embodiments, the integrated map can include different types of information based on the measured photoluminescence and topography data. The apparatus 10 can be a freestanding system separate from a workpiece processing tool, or the apparatus 10 can be a component of a processing tool that performs a process on the workpiece (e.g., growing epitaxial layers, etching, patterning, planarizing, plating, etc.).

In the illustrated embodiment, the apparatus 10 includes a radiation source 20 configured to generate one or more beams 22 at a desired wavelength. The radiation source 20 can be any of a variety of radiation sources known in the art, such as laser systems and/or lamps. The nature of the source depends upon the intended application. In one embodiment, for example, the radiation source 20 can be a laser capable of producing (a) a beam 22 at a single wavelength, or (b) a plurality of beams 22 having different wavelengths. In the illustrated embodiment, a first beam 22a having a first wavelength and a second beam 22b having a second wavelength different than the first wavelength are produced by the radiation source 20. In other embodiments, the radiation source 20 may include multiple lasers or lamps that each produce one or more beams with a desired wavelength.

The beams 22a and 22b are directed to an optical assembly 30. The optical assembly 30 includes an optics subsystem 32 that conditions the beams 22a and 22b to form one or more conditioned beams 23 (illustrated as conditioned beams 23a and 23b, respectively). The optics subsystem 32 is an optical head that can include a variety of lenses, filters, and/or optical elements to condition the beams 22a and 22b. In several embodiments, for example, the optics subsystem 32 includes a beam expander, a beam splitter, and a plurality of lenses and/or filters. In other embodiments, the optics subsystem 32 can include other elements.

The conditioned beams 23a and 23b are directed from the optics subsystem 32 to one or more portions of the workpiece 12 carried by a support member 40. At least one of the support member 40 and the optical assembly 30 is adapted to move relative to the other to change the relative orientation of the workpiece 12 and the optical assembly 30. In the illustrated embodiment, for example, a motor 44 (shown in hidden lines) is operatively coupled to the support member 40 to move the workpiece 12 with respect to optical assembly 30 in the x-, y-, and/or z-directions. In this way, the conditioned beams 23a and 23b are directed onto the desired portions of the workpiece 12. Alternatively, the optical assembly 30 can be moved relative to the support member 40, or both the optical assembly 30 and the support member 40 can be moved relative to each other.

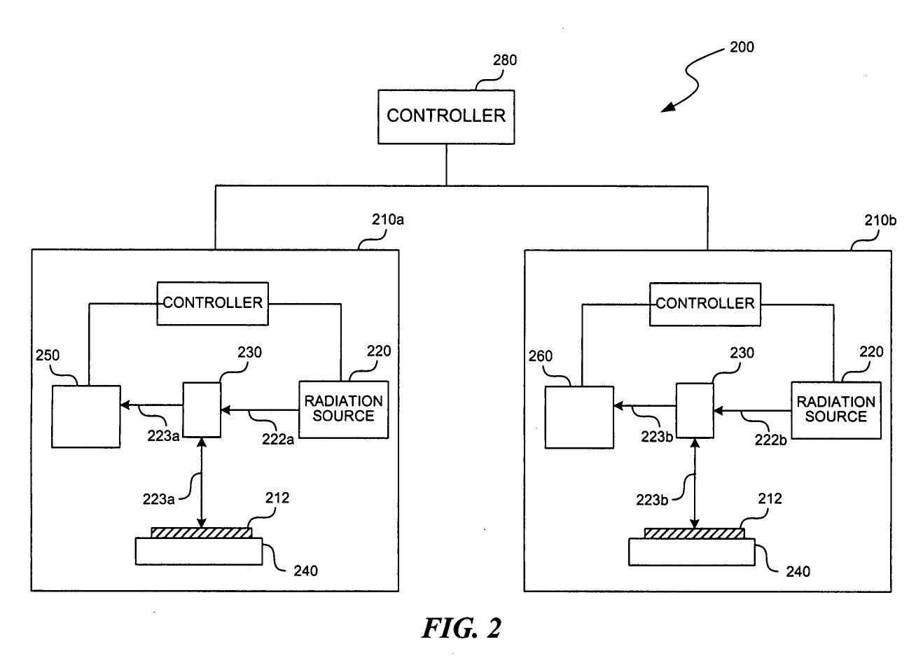

The optics subsystem 32 is also configured to receive radiation reflected or emitted from the workpiece 12 (also shown as beams 23a and 23b) and transmit the reflected radiation to a first metrology unit 50 and/or a second metrology unit 60 for analysis. In the illustrated embodiment, the first metrology unit 50 is configured to measure photoluminescence from the workpiece 12 and the second metrology unit 60 is configured to determine a topographical profile of the workpiece 12. In the embodiment shown in FIG. 1, the first metrology unit 50 and second metrology unit 60 are both part of the optical assembly 30 and are both configured to use the single optics subsystem 32. In other embodiments, however, the first and second metrology units 50 and 60 may not use a single optics subsystem 32 (i.e., separate optics subsystems). For example, in several embodiments the first and second metrology units 50 and 60 may still be components within the same optical assembly, but may each include a dedicated optics subsystem. In still further embodiments (as described below with reference to FIG. 2), the first and second metrology units 50 and 60 may be in completely independent tools.

The first metrology unit 50 can include a first detector 52 and a first processor 54 operatively coupled to the first detector 52. The first detector 52 includes lenses, filters, and/or other mechanisms to isolate certain wavelengths of the reflected radiation and measure the photoluminescence from the workpiece 12. The first processor 54 evaluates the photoluminescence data and forms a photoluminescence map of the workpiece 12. The second metrology unit 60 includes a second detector 62 and a second processor 64. The second detector 62 can also include a number of lenses, filters, and/or other mechanisms to evaluate the reflected radiation and produce a condition signal. The second processor 64 is operatively coupled to the second detector 62 and evaluates the geometry of the surface of the workpiece 12 based on the condition signal from the second detector 62 to produce a topographical profile of the workpiece's surface.

The apparatus 10 further includes a controller 70 operatively coupled to the first metrology unit 50 and the second metrology unit 60. The controller 70 of this embodiment is configured to associate the data from the first metrology unit 50 and the second metrology unit 60. The controller 70, for example, can include a computer-readable medium that receives and associates data regarding the photoluminescence (e.g., the photoluminescence map) and topology (e.g., the topographical profile) of the workpiece 12 to produce an integrated map of the workpiece. The method used by the controller to associate the data is described in greater detail below in Section C. In this embodiment, the controller 70 is also operatively coupled to the radiation source 20 to operate and/or monitor the output of the radiation source 20. In alternative embodiments, the controller 70 may also control operation of the optics subsystem 32 and/or other portions of the apparatus 10.

One advantage of the apparatus 10 described above is that the first metrology unit 50 and the second metrology unit 60 are both configured to use the same optics subsystem 32 or at least share a portion of the same optics subsystem 32. The lenses, filters, and/or other optical elements that make up the optics subsystem 32 can be complex and extremely sensitive components of the apparatus 10. Therefore, the use of a single set of optics is expected to substantially reduce the complexity of the apparatus 10 compared to conventional systems having separate photoluminescent and topology tools.

Another advantage of the apparatus 10 is that the use of a single optics subsystem 32 is expected to quickly perform the analysis process with a high degree of accuracy. For example, after measuring the photoluminescence from a desired portion of the workpiece 12, the topography of that same portion of the workpiece 12 can be measured without moving the workpiece to a different tool and realigning the workpiece. Moving a workpiece to a different tool as required by conventional systems is time consuming and can introduce contamination or cause damage to the workpiece. Moreover, the realignment process required by conventional systems is further time consuming because the workpiece 12 and the optical assembly 30 must be aligned precisely to avoid potential errors. Accordingly, the apparatus 10 is expected to (a) significantly reduce the time for analyzing both the photoluminescence and topography of a workpiece, and (b) eliminate a source of potential errors resulting from misalignment.

Yet another advantage of the apparatus 10 is that the integrated map produced by the apparatus can be used to accept or reject individual workpieces or entire batches of workpieces if they fall outside of desired specifications. This feature can prevent the processing and/or testing of unacceptable workpieces, which in turn will reduce costs and increase throughput for processing and fabrication.

FIG. 2 is a schematic illustration of an apparatus 200 for analyzing a semiconductor workpiece 212 in accordance with another embodiment of the invention. The apparatus 200 differs from the apparatus 10 described above with respect to FIG. 1 in that the components of the apparatus 200 are not housed in a single chamber of a single tool. Rather, the apparatus 200 includes a first tool 210a housing a first metrology unit 250 and a second tool 210b housing a second metrology unit 260. Accordingly, the workpiece 212 must be moved from the first tool 210a to the second tool 210b and realigned to complete analysis of the workpiece 212 and form an integrated map of the workpiece. In the illustrated embodiment, the first tool 21 Oa is configured to measure the photoluminescence of the workpiece 212 and the second tool 210b is configured to determine the topographical profile of the workpiece 212. Suitable tools for measuring photoluminescence of the workpiece are described in PCT Application No. WO 98/11425, which is hereby incorporated by reference, and include the SiPHER™ tool commercially available from Accent Optical Technologies of Bend, Oregon. Suitable tools for determining the topographical profile of the workpiece are commercially available from KLA-Tencor Corporation of San Jose, California, Zygo Corporation of Middlefield, Connecticut, and ADE Corporation of Westwood, Massachusetts.

The various components of the first and second tools 210a and 210b can be generally similar to those described above with respect to FIG. 1. Accordingly, the specific details of the various components will not be described in detail. The first and second tools 210a and 210b, for example, each include a radiation source 220 configured to direct one or more beams 222 (shown as beams 222a and 222b) to an optical assembly 230 that conditions the beams 222 to form conditioned beams 223 (shown as beams 223a and 223b). The conditioned beams 223a and 223b are directed to one or more portions of the workpiece 212 carried by a support member 240. The radiation reflected by the workpiece 212 is in turn transmitted to either the first metrology unit 250 of tool 210a or the second metrology unit 260 of tool 210b for analysis.

In several embodiments, for example, the workpiece 212 can be positioned within the first tool 210a to form a photoluminescence map of the workpiece 212. The workpiece 212 can then be moved to the second tool 210b and realigned using methods known to one of ordinary skill in the art. The second metrology tool 260 determines a topographical profile of the workpiece 212. A controller 280 operatively coupled to both the first tool 210a and the second tool 210b can then associate the photoluminescence data and the topographical profile from the workpiece 212 to form an integrated map of the workpiece. In alternative embodiments, the first tool 210a and/or the second tool 210b may have different combinations of components. Furthermore, the topographical profile of the workpiece 212 may be determined before measuring the photoluminescence.

C. Embodiments of Methods for Analyzinq a Semiconductor Workpiece

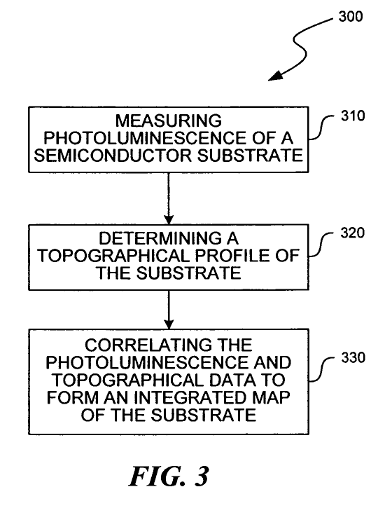

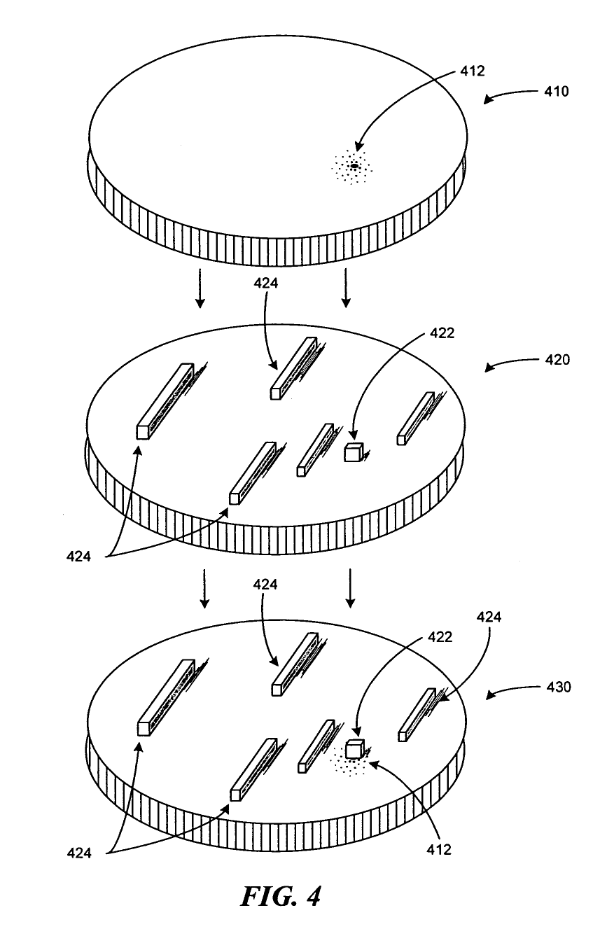

FIG. 3 is a flow chart illustrating one embodiment of a method 300 for analyzing a semiconductor workpiece using photoluminescence and topographical data in accordance with the invention. The method 300 can be performed using the apparatuses 10 or 200 described above with respect to FIGS. 1 and 2, respectively, or other suitable apparatuses. FIG. 4 is a partially schematic isometric view of a photoluminescence map of the semiconductor workpiece, a topographical map of the workpiece, and an integrated map formed using the method 300.

Referring to FIGS. 3 and 4 together, the method 300 includes measuring photoluminescence of the workpiece at stage 310. The photoluminescence data from various portions of the workpiece is correlated to form a photoluminescence map 410 (FIG. 4) of the workpiece. The photoluminescence map 410 can include, for example, information on the uniformity of alloy composition, material quality, epilayers, device structures, contamination, state of crystallinity, and other defects. In the illustrated example, the photoluminescence map 410 identifies a portion 412 as a stray copper particle on the workpiece. In other embodiments, the photoluminescence map 410 may identify a variety of other anomalies and/or materials on and/or in the workpiece.

The method 300 also includes determining a topographical profile of the workpiece at stage 320. The topographical profile describes the surface features and flaws on the workpiece. The topographical data is correlated to form a topographical map 420 (FIG. 4) of the workpiece. In the illustrated example, the topographical map 420 shows the stray copper particle as a bump 422 on the workpiece, rather than an embedded impurity within the workpiece. The topographical map 420 can also identify various other geometrical features 424 on the surface of the workpiece.

The method 300 further includes associating the photoluminescence data and topographical profile at stage 330 to form an integrated map 430 (FIG. 4) of the workpiece. More specifically, the photoluminescence map 410 and the topographical map 420 are overlaid to form the integrated map 430. The integrated map 430 includes both the photoluminescence data (e.g., the portion 412) and the topographical information (e.g., the bump 422 and features 424).

One advantage of the integrated map 430 is that the topographical information provides the ability to look more deeply into the photoluminescence data. For example, the photoluminescence map can highlight an anomaly, but it can be difficult to determine whether the anomaly is a particle on the surface of the workpiece or a defect within the workpiece. The topographical profile provides additional information about the anomaly so that the characteristics of the anomaly can be quickly determined (e.g., surface particle or embedded defect). In this way, the particle can either be removed before it contaminates the workpiece or the workpiece can be scrapped before wasting additional manufacturing resources.

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Accordingly, the invention is not limited except as by the appended claims.

I/We claim:

1. An apparatus for analyzing a semiconductor workpiece, the apparatus comprising:
a first metrology unit configured to measure photoluminescence from the workpiece;
a second metrology unit configured to determine a topographical profile of the workpiece; and
a control unit operatively coupled to the first metrology unit and the second metrology unit to receive and associate data regarding the photoluminescence and the topographical profile to produce an integrated map of the workpiece.

2. The apparatus of claim 1, further comprising a radiation source configured to irradiate at least a portion of the workpiece, and wherein:
the first metrology unit includes (a) a first detector to measure photoluminescence from the irradiated portion of the workpiece, and (b) a first processor operatively connected to the first detector to produce a photoluminescence map of the workpiece; and
the second metrology unit includes (a) a second detector to measure radiation reflected from the irradiated portion of the workpiece and generate a condition signal in response thereto; and (b) a second processor operatively coupled to the second detector for evaluating the geometry of a surface of the workpiece based on the condition signal to produce a topographical profile of the workpiece.

3. The apparatus of claim 1 wherein:
the first metrology unit includes (a) a first radiation source configured to irradiate at least a portion of the workpiece, and (b) a first detector configured to measure photoluminescence from the irradiated portion of the workpiece; and
the second metrology unit includes (a) a second radiation source configured to irradiate at least a portion of the workpiece, and (b) a second detector configured to determine a topographical profile of the irradiated portion of the workpiece.

4. The apparatus of claim 1 wherein the first metrology unit includes:
a radiation source configured to direct a beam of radiation having a desired wavelength to the workpiece; and
a detector configured to measure photoluminescence from the workpiece.

5. The apparatus of claim 1 wherein the second metrology unit includes:
a radiation source configured to direct a beam of radiation having a desired wavelength to the workpiece; and
a detector configured to determine a topographical profile of the workpiece.

6. The apparatus of claim 1 wherein the first metrology unit and the second metrology unit are housed in a single tool having a cabinet, and wherein the first metrology unit and the second metrology unit are in the cabinet.

7. The apparatus of claim 6 wherein the first metrology unit and the second metrology unit are components of a single optical assembly of the tool.

8. The apparatus of claim 7 wherein the optical assembly includes an optics subsystem, and wherein the first metrology unit and the second metrology unit are both configured to use the optics subsystem.

9. The apparatus of claim 6 wherein the first metrology unit is a component of a first optical assembly and the second metrology unit is a component of a second optical assembly.

10. The apparatus of claim 1 wherein the first metrology unit and the second metrology unit are in separate tools.

11. An apparatus for analyzing a semiconductor workpiece, the apparatus comprising:
a radiation source configured to irradiate at least a portion of the workpiece;
a first metrology unit configured to measure photoluminescence from the workpiece, the first metrology unit including (a) a first detector to measure photoluminescence from the irradiated portion of the workpiece, and (b) a first processor operatively connected to the first detector to produce a photoluminescence map of the workpiece;
a second metrology unit configured to determine a topographical profile of the workpiece, the second metrology unit including (a) a second detector to measure radiation reflected from the irradiated portion of the workpiece and generate a condition signal in response thereto, and (b) a second processor operatively coupled to the second detector for evaluating the geometry of the surface of the workpiece based on the condition signal to produce a topographical profile of the surface of the workpiece; and
a control unit operatively coupled to the first metrology unit and the second metrology unit to receive and associate data from the photoluminescence map and the topographical profile to produce an integrated map of the workpiece.

12. The apparatus of claim 11 wherein the radiation source provides radiation of a desired wavelength to both the first metrology unit and the second metrology unit.

13. The apparatus of claim 11 wherein the radiation source comprises a light source configured to direct a first beam of radiation having a first wavelength to the workpiece and a second beam of radiation having a second wavelength to the workpiece.

14. The apparatus of claim 11 wherein the first metrology unit and the second metrology unit are housed in a single tool having a cabinet, and wherein the first metrology unit and the second metrology unit are in the cabinet.

15. The apparatus of claim 14 wherein the first metrology unit and the second metrology unit are components of a single optical assembly of the tool.

16. The apparatus of claim 15 wherein the optical assembly includes an optics subsystem, and wherein the first metrology unit and the second metrology unit are both configured to use the optics subsystem.

17. The apparatus of claim 14 wherein the first metrology unit is a component of a first optical assembly and the second metrology unit is a component of a second optical assembly.

18. The apparatus of claim 11 wherein the first metrology unit and the second metrology unit are in separate tools.

19. An apparatus for analyzing a semiconductor workpiece, the apparatus comprising:
a first metrology unit;
a second metrology unit; and
a control unit operatively coupled to the first metrology unit and the second metrology unit, the control unit having a computer-readable medium containing instructions to perform a method comprising
irradiating the workpiece with radiation having a first wavelength;
measuring photoluminescence from the portion of the workpiece irradiated with the first wavelength of radiation using the first metrology tool;
irradiating the workpiece with radiation having a second wavelength, the second wavelength being different than the first wavelength;
determining a topographical profile of the portion of the workpiece irradiated with the second wavelength of radiation using the second metrology unit; and
forming an integrated map of the workpiece based on the measured photoluminescence and topographical profile.

20. The apparatus of claim 19 wherein:
the instructions for measuring photoluminescence from the workpiece comprise (a) ascertaining a first value of photoluminescence resulting from irradiating a first section of the workpiece with radiation having the first wavelength, and (b) ascertaining a second value of photoluminescence resulting from irradiating a second section of the workpiece with radiation having the first wavelength;
the instructions for determining a topographical profile of the workpiece comprise (a) ascertaining a first geometry of a surface of the first section of the workpiece by irradiating the first section of the workpiece with radiation having the second wavelength, and (b) ascertaining a second geometry of a surface of the second section of the workpiece by irradiating the second section of the workpiece with radiation having the second wavelength; and
the instructions for forming an integrated map of the workpiece comprise associating the photoluminescence data and topographical profile data from the individual sections of the workpiece to form the integrated map of the workpiece.

21. The apparatus of claim 19 wherein the first metrology unit and the second metrology unit are housed in a single tool having a cabinet, and wherein the first metrology unit and the second metrology unit are in the cabinet.

22. The apparatus of claim 21 wherein the first metrology unit and the second metrology unit are components of a single optical assembly of the tool.

23. The apparatus of claim 22 wherein the optical assembly includes an optics subsystem, and wherein the first metrology unit and the second metrology unit are both configured to use the optics subsystem.

24. The apparatus of claim 21 wherein the first metrology unit is a component of a first optical assembly and the second metrology unit is a component of a second optical assembly.

25. The apparatus of claim 19 wherein the first metrology unit and the second metrology unit are in separate tools.

26. An apparatus for analyzing a semiconductor workpiece, the apparatus comprising:
means for measuring photoluminescence from a semiconductor workpiece;
means for determining a topographical profile of a surface of the workpiece; and
control means for associating data from the photoluminescence means and the topographical profile means to produce an integrated map of the workpiece.

27. The apparatus of claim 26 wherein the photoluminescence means and topographical profile means are housed in a single tool having a cabinet, and wherein the first metrology unit and the second metrology unit are in the cabinet.

28. A method for analyzing a semiconductor workpiece, the method comprising:
irradiating a portion of a workpiece;
measuring photoluminescence from the irradiated portion of the workpiece;
determining a topographical profile of the irradiated portion of the workpiece; and
forming an integrated map of the workpiece based on the measured photoluminescence and topographical profile.

29. The method of claim 28 wherein measuring the photoluminescence of the workpiece is performed by a first metrology unit and determining the topographical profile of the workpiece is performed by a second metrology unit, and wherein the first and second metrology units are both housed in a cabinet of a single tool.

30. The method of claim 28 wherein measuring the photoluminescence of the workpiece is performed by a first metrology unit and determining the topographical profile of the workpiece is performed by a second metrology unit, the first and second metrology units being in separate tools.

31. The method of claim 28 wherein:
irradiating a portion of the workpiece comprises impinging a first beam of radiation upon a plurality of sections of the workpiece;
measuring photoluminescence from the irradiated portion of the workpiece comprises (a) ascertaining values of photoluminescence resulting from impinging the first beam upon the sections of the workpiece, and (b) forming a photoluminescence map of the workpiece based on data from at least some of the sections of the workpiece;
determining a topographical profile of the irradiated portion of the workpiece comprises (a) ascertaining a geometry of the individual sections of the workpiece, and (b) forming a topographical map of the workpiece based on data from at least some of the sections of the workpiece; and
forming an integrated map of the workpiece comprises associating the data from the photoluminescence map and the topographical map into a single map of the workpiece.

32. A method for analyzing a semiconductor workpiece, the method comprising:
irradiating the workpiece with radiation having a first wavelength;
measuring photoluminescence from the portion of the workpiece irradiated with the first wavelength of radiation using a first metrology tool;
irradiating the workpiece with radiation having a second wavelength, the second wavelength being different than the first wavelength;
determining an optical profile of the workpiece irradiated with the second wavelength of radiation using the second metrology unit; and
forming an integrated map of the workpiece based on the measured photoluminescence and optical profile.

33. The method of claim 32 wherein:
irradiating the workpiece with radiation having a first wavelength comprises impinging a beam of radiation having the first wavelength upon a plurality of sections of the workpiece;
measuring photoluminescence from the workpiece comprises (a) ascertaining values of photoluminescence resulting from impinging the first beam upon the sections of the workpiece, and (b) forming a photoluminescence map of the workpiece based on data from at least some of the sections of the workpiece;
irradiating the workpiece with radiation having a second wavelength comprises impinging a beam of radiation having the second wavelength upon the plurality of sections of the workpiece;
determining an optical profile of the workpiece comprises (a) ascertaining a geometry of the individual sections of the workpiece, and (b) forming a topographical map of the workpiece based on optical profile data from at least some of the sections of the workpiece; and
forming an integrated map of the workpiece comprises associating the data from the photoluminescence map and the topographical map into a single map of the workpiece.

34. The method of claim 32, further comprising:
irradiating the workpiece with radiation having a third wavelength, the third wavelength being different than the first and second wavelengths; and
measuring photoluminescence from the portion of the workpiece irradiated with the third wavelength using the first metrology tool.

35. The method of claim 34 wherein irradiating with workpiece with radiation having the first wavelength and irradiating the workpiece with radiation having the third wavelength occur at different times.

36. The method of claim 34 wherein irradiating with workpiece with radiation having the first wavelength and irradiating the workpiece with radiation having the third wavelength occur approximately simultaneously.
